(19) United States
(12) Patent Application Publication
(10) Pub. No.: US 2010/0153238 A1
(43) Pub. Date: Jun. 17, 2010

(54) Suggesting a Transaction Between Parties Based on Inventory

(76) Inventor: Basem Zaghloul, Wayne, NJ (US)

Correspondence Address: Law Office of Michael J. Feigin, 103 The Circle, (http://PatentLawNY.com), Passaic, NJ, 07055, US

(21) Appl. No.: 12/335,586

(22) Filed: Dec. 16, 2008

(51) Int. Cl. G06N 5/02; G06Q 10/00; G06F 17/30; G06F 7/06

(52) U.S. Cl. 705/28; 706/52; 707/E17.032

(57) ABSTRACT

A method for suggesting a transaction in the disclosed technology proceeds by comparing an inventory of a transactor with a desired inventory of a plurality of other transactors. A desired inventory of the transactor is also compared with an inventory of the plurality of other transactors. A distance between the at least one transactor and the plurality of other transactors is compared. The plurality of other transactors and the at least one transactor are ranked together based on the comparing and the determining. At least one transaction between the transactor and at least one of the plurality of other transactors is then suggested.

### FIELD OF THE DISCLOSED TECHNOLOGY

The disclosure refers generally to commerce between parties and more specifically to determining parties for conducting a transaction.

### BACKGROUND OF THE DISCLOSED TECHNOLOGY

Commerce between parties is, of course, well known. The basic concept is that the first person has product A and the second person has product B. Person A and B get together and trade some of A for some of B. Product A and/or B may be something occurring naturally, something formed by the hand or mind of man, or a combination thereof. Jumping forward in time, commerce on this basic level still occurs in stores, catalogs, and now on websites. Still, however, if person B wants to buy from person A, each party must somehow advertise what he or she has and/or what he or she wants, in order to get a buyer and seller or traders together.

The system is largely inefficient. If A advertises that he has a widget x, then this advertisement may go out to 10,000 people to get one buyer. If B is seeking to buy x, he must go to many places (physical or online) to find the proper product. In both cases, the cost of producing and marketing the goods for each sale that takes place is built into the price, including the cost of advertising to the many who don't buy. Furthermore, the parties, and in most cases the goods, must travel to each other to effect the sale and also to transfer the goods from party to party. Often, the shipping costs or driving time alone are enough overhead to discourage the transaction.

Prior art advancements in the ability to get buyer and seller together while decreasing transaction costs have their limitations. For example, U.S. Patent Publication 2005/0102200 to Carnes discloses listing text books for sale amongst university students to allow a buyer and seller to find each other. U.S. Patent Publication 2005/0004948 discloses allowing a buyer and seller to meet based on the distance between them. U.S. Patent Publication 2005/0187827 to Weiss et al. discloses matching traders based on their inventory. In typical embodiments of the prior art, the net result for the consumer is that he or she must sort through many lists of products and services to find what he or she wants and may be missing out on many opportunities to sell his or her own goods or services to others. Simply put, there is much waste in our economic systems.

What is needed in the art of commerce is a way to connect buyers and sellers more efficiently. Doing so would cut down on transaction costs, waste, and inefficiencies.

### SUMMARY OF THE DISCLOSED TECHNOLOGY

It is therefore an object of the present invention to provide a method and device for connecting transactors, that is, buyers, sellers, and/or traders, to conduct commerce in the most efficient manner.

It is a further object of the invention to allow such transactors to come together based on the inventory, such as the goods or services available to, controlled by, or owned by each transactor, and the desired inventory of each transactor.

It is a further object of the invention to allow such transactors to come together based on their distance from each other and group association.

It is a still further object of the invention to allow the transactors to come together based on an assignment of a weight relative to the distance, inventory, group association, and so forth of each factor.

It is yet another object of the invention to allow the transactors to choose the relative weight of the above based on their individual preferences.

A method for suggesting a transaction in the disclosed technology proceeds by comparing an inventory of a transactor with a desired inventory of a plurality of other transactors. A desired inventory of the transactor is also compared with an inventory of the plurality of other transactors. The distances between the at least one transactor and the plurality of other transactors are compared. The plurality of other transactors and the at least one transactor are ranked together based on the comparing and the determining. At least one transaction between the transactor and at least one of the plurality of other transactors is then suggested.

The comparing may further be carried out by comparing a group association between the transactor and the plurality of other transactors. The step of ranking may further be based on assigning a relative weight to each of the said comparing and said determining. The relative weight may be assigned by the at least one transactor.

At least two items selected from an existing inventory or a desired inventory may be assigned a relative weight in the ranking, and this relative weight may be assigned by the transactor or a member of the plurality of other transactors.

A plurality of locations may be received from at least one of the transactors, and the determination of distance may be based on the closest distance between the at least one transactor and the plurality of other transactors. The plurality of locations may be received from at least one of the transactors and the determination of distance may be based on a relative weight assigned to each location. A relative weight of each location may be assigned to at least two locations, each by a separate transactor.

A computer readable storage medium comprising instructions for carrying out the above method and a device configured to carry out the method are also contemplated as being within the scope of the disclosed technology.

### BRIEF DESCRIPTION OF THE DRAWINGS

FIG. 1 shows a high level diagram of a method of carrying out an embodiment of the disclosed technology.

FIG. 2 shows a high level block diagram of a method of assigning relative weights to data associated with a transactor in an embodiment of the invention.

FIG. 3 shows a high level block diagram of a method of ranking transactors in embodiments of the disclosed technology.

FIG. 4 shows locations of a first and second transactor in an embodiment of the invention.

FIG. 5 shows a method of selecting relative weights which are used to rank transactors in embodiments of the invention.

FIG. 6 shows an example of information presented to a transactor when suggesting at least one transaction in an embodiment of the invention.

FIG. 7 shows a high-level block diagram of a computer that may be used to carry out the invention.

### DETAILED DESCRIPTION OF EMBODIMENTS OF THE DISCLOSED TECHNOLOGY

Embodiments of the present technology comprise a method for suggesting a transaction by comparing inventories and desired inventories of transactors. A transactor is one who is conducting or seeking to conduct the buying, selling, trading, or combination thereof of any items in the inventories. An inventory comprises a product (goods) or service offering or desiring to be transacted with, that is, bought, sold, or bartered. Distance between the transactors is also taken into account as is, in some embodiments of the invention, group association of the transactors (i.e., two transactors associated with the same organization, group of friends in a social network, or the like may receive high preference for conducting a transaction with each other, and distance from each other may also be taken into account). The transactors are ranked together based on any or all of the above, and at least one transaction between two transactors is suggested and the parties may contact one another to conduct such a transaction. Relative values to any one of the items (a good or service) in an inventory may be assigned and taken into account in the ranking and/or suggesting. Relative values may similarly be assigned to how well the inventories (owned and/or desired) compare to each other, as well as weighting inventory versus distance.

The embodiments of the invention will become clear in light of the description of the following figures.

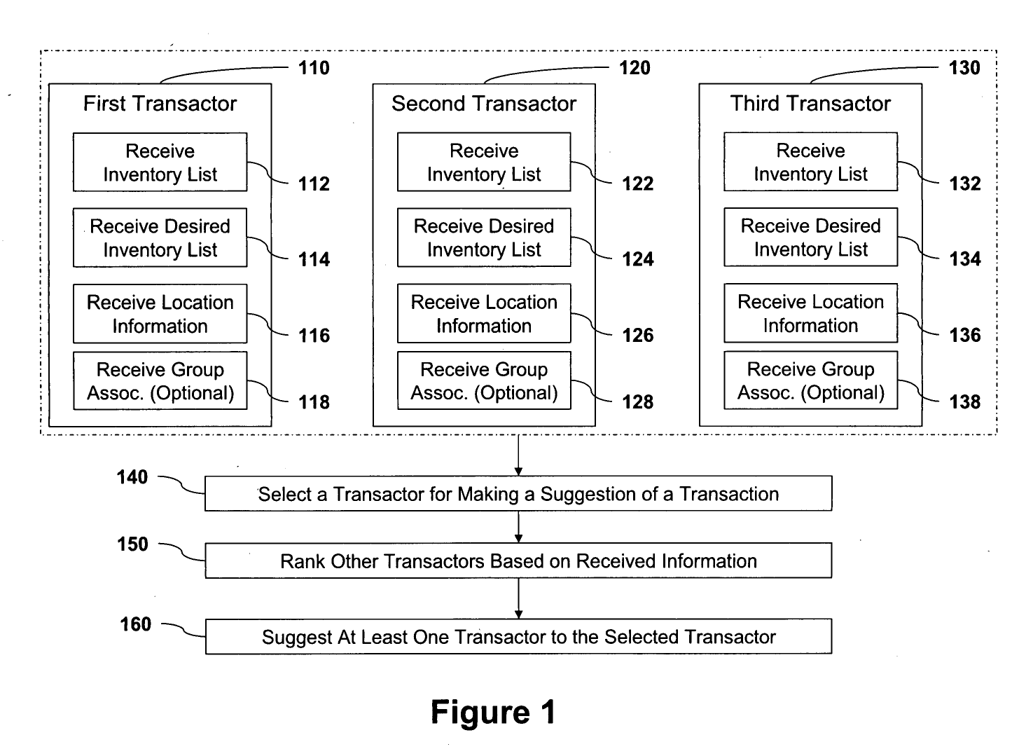

FIG. 1 shows a high level diagram of a method of carrying out an embodiment of the disclosed technology. Three transactors 110, 120, and 130 have goods and services to sell, buy, and trade, or any combination thereof. It should be understood that actual embodiments of the invention may or do comprise the use of many more transactors, such as into the hundreds or thousands. In steps 112, 122, and 132, a list of inventory is received from each transactor. The inventory comprises a list of goods or services in the possession of the respective transactor. For example, transactor 110 may have textbooks to sell or trade; transactor 120 may have other textbooks to sell or trade; and transactor 130 may have computer services to offer.

In steps 114, 124, and 134, a desired inventory is received from the respective transactors, 110, 120, and 130. The desired inventory of each transactor is a list of goods and/or services that the transactor wishes to obtain by buying or trading. For example, transactor 110 may wish to buy/trade for other text books. Transactor 120 may wish to buy/trade for home furnishings and someone to remove a virus from his computer. Transactor 130 may wish to buy/trade for home furnishings.

In steps 116, 126, and 136, location information is received from the transactors 110, 120, and 130. This information may comprise one or more locations of each transactor such as a home address, work address, and school address. The transactor who sends location information may weight one location higher than another when used in calculations, such as by selecting a preferred location. Weighting will be discussed in greater detail below. In any case, the multiple locations may be used for purposes of calculating distances between two transactors, so that the closest addresses, for example, may be selected for ranking transactors with each other.

In steps 118, 128, and 138 a group association or a plurality thereof may be received from the respective transactors. This is an optional step but may be required or used by default in embodiments of the invention. People may prefer to conduct transactions (buying, selling, or trading) with those that, for example, are amongst a networking group as part of an online social network (i.e., in the “pet lovers” or “Rutgers alumni” group on LinkedIn, Facebook, or another social network, including an online message group). In this manner, embodiments of the invention may be an extension to an online social network or may be a stand-alone system. The group association may have to match up a first transactor and a second transactor if one of the transactors or an embodiment of the invention requires it, or it may be used as a criterion for comparing the rankings of transactors. As another example of use of the group association requirement or weighting, those trading textbooks may desire to only transact with other students at the same university for safety reasons, convenience, or location.

In step 140, a selection of a transactor to make a transaction suggestion is made. This may be done in one of many ways. An individual transactor may explicitly request another to conduct a transaction with, such as by sending data to or informing a computer server comprising code for carrying out embodiments of the invention, or by asking a person for a selection of a transaction. The choice may also be implicit. A transactor may be selected on the basis of completing a profile comprising at least some inventory, desired inventory, and location information, selected at regular intervals, such as is part of sending a daily or weekly e-mail, newsletter, or update to the transactor with most relevant suggested transactions. The loading of a webpage, such as a website associated with embodiments of the invention or a social network profile page of a transactor, may cause, such as by sending data, a transactor to be selected.

Once a transactor is selected, such as transactor 110, 120, or 130, for making a suggestion to same, then, in step 150, the other transactors are ranked based on the information received in steps 112-118, 122-128, and 132-138. For example, if transactor 110 is selected, then the other transactors—in this example, transactors 120 and 130—will be ranked based on a comparison of inventories, location, and group association relative to transactor 110. In this manner, for each transactor, transaction suggestions can be made which decrease inefficiencies and wastes in economic systems and allow parties to come together which are well suited to do business with each other, whether it be the trading, buying, or selling of goods and services, such as, text books, computer repair, home furnishings, or the like.

In step 160, at least one transactor is suggested to the selected transactor. Contact information (received from each transactor or a database comprising transactor identification information), such as an email address, profile name, address, phone number or the like, which corresponds to an individual transactor, may be or is forwarded to the selected transactor or another person, entity, or script acting on behalf of the selected transactor, or having a monetary interest in the selected transactor's transaction. This step may comprise the sending of such information about one transactor, such as the most highly ranked transactor, or the sending of a plurality of transactors and the associated contact information.

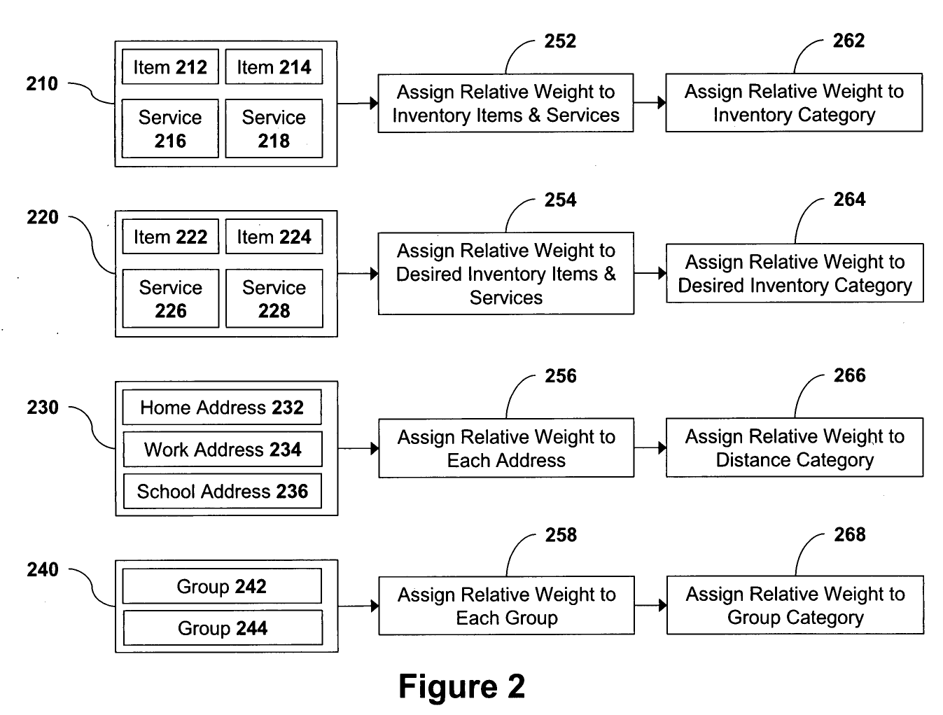

FIG. 2 shows a high level block diagram of a method of assigning relative weights to data associated with a transactor in an embodiment of the invention. Transactor 110, for example, may have in his possession (control or ability to service others) inventory or information about the inventory which is stored in an inventory database 210. The inventory database 210 may comprise information about one or more items, such as item 212 and item 214. These items may be any type of goods, whether movable or unmovable. A common example might be a book or compact disc and associated datum which may also be entered, such as ISBN number or title, author, and the like. Condition of the inventory, asking price, hourly rate, and other indicia referring to the value of the item or service may also be stored. Transactor 110 may also be able to provide services such as service 216 and service 218. The services may be those of a patent prosecution, medical treatment, computer repair, housecleaning, or the like.

In step 252, a relative weight is assigned to each item and service in the inventory. As with all of the relative weights in embodiments of the invention, the weighting may be accomplished automatically, such as by using a predetermined weight which is determined to yield desired results, or by assigning equal weights. For example, items 212 and 214 and service 216 and 218 may each be given equal weights with respect to one another, or it may be determined in embodiments of the invention that goods yield the most successful transactions or a specific item is traded frequently. Thus, a system configured to carry out embodiments of the invention might be configured to weight item 212 heavier than item 214. Similarly, items might be weighted higher than services. So item 212 and 214 may, for example, each receive a 40% weight in the inventory, and each service 216 and 218 may receive a 20% weight. Alternatively, a transactor, such as the transactor 110, a selected transactor, or another transactor may assign weights to specific items and services which may be used to set the weights or modify previously assigned weights (such as by averaging an assigned weight of an item by transactor 110 and a assigned weight of an item by transactor 120 when matching an inventory of transactor 110 with a desired inventory of transactor 120). A transactor may also specify not to return any results that do not, for example, include the selling of a specific item or service.

Information about a desired inventory is stored in a desired inventory database 220. Desired inventory comprises goods and/or services which a transactor seeks to purchase or receive through a trade. This may include items such as item 222 or item 224. This may also include services such as service 226 or service 228. In step 254, relative weights are assigned to each item or service, or category of items and services, in a manner similar to that described with reference to step 252.

Location database comprises one or more locations of a transactor, such as a home address 232, work address 234, or school address 236. The relative weights of the addresses are assigned in step 256 in a manner similar to steps 252 and 254. It may be desired to use one or more of these addresses in association with a specific group. For example, if two transactors are in the same group, in step 256, when assigning a relative weight to the addresses, a higher weight may be given to a school address when the transactors being compared are both in a school-related group, indicating that they are most likely to be closest when both at school, or, where a school address is given, to weight this address higher when school is typically in session (i.e., August 25-December 10 and January 20-May 15). Alternatively, instead of assigning a relative weight in step 258, the closest address of the selected transactor and a transactor being compared to may be taken into account and used to determine distance. This will be explained in greater detail with respect to later figures.

In steps 262, 264, 266, and 268, relative weights are assigned to the categories. That is, the importance given to each category as a whole is assigned by any of the methods described above. These steps may be carried out in any order and may be carried out or updated with the assigning of relative weights in steps 252, 254, 256, and 258. In step 262, a relative weight is assigned to the inventory category (again, this is the inventory of a transactor), and in step 264, a relative weight is assigned to the desired inventory category. In step 266, a relative weight is assigned to the distance category. In step 268, a relative weight is assigned to the group category. Each of these categories may be assigned an equal rate (i.e., 25% each or 33% each, when group association is not used).

In short, relative weights can be assigned to each category with respect to each other, by data within a category itself, or a hybrid thereof, where a certain condition must be met, such as having/wanting an item, being within a certain distance, or being a member of a certain group before allowing a suggestion of a transaction to be ranked. The weighting affects calculations of rank of a suggestion between two transactors and the resulting data presented to a transactor. The relative weighting may take place in any order, and defaults may be used.

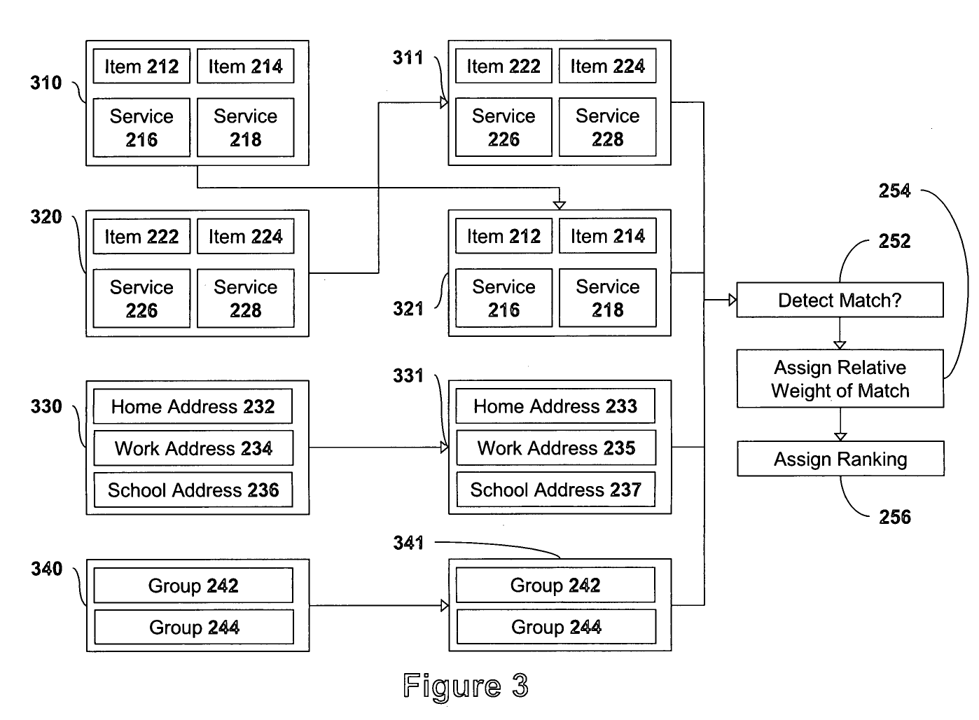

FIG. 3 shows a high level block diagram of a method of ranking transactors in embodiments of the disclosed technology. A first transactor has inventory 310 (comprising, for example, item 212, item 214, service 216, and service 218), desired inventory 320 (comprising, for example, item 222, item 224, service 226, and service 228), locations 330 (comprising, for example, home address 232, work address 234, and school address 236), and group associations 340 (comprising, for example, groups 242 and 244). A second transactor has inventory 311 (in this example, identical to the desired inventory 320 of the first transactor), desired inventory 321 (in this example, identical to the inventory 310 of the first transactor), locations 331 (comprising, for example, home address 233, work address 235, and school address 237), and group associations 341 (in this example, identical to the group associations 340).

The data of the first transactor are compared to at least one other transactor in order to determine if there is a match of inventory to buy, sell, or trade in the following manner, based on the data received, such as has been described with reference to FIGS. 1 and/or 2. The inventory 310 of the first transactor is compared to the desired inventory 321 of the second transactor. The desired inventory 320 of the first transactor is compared to the inventory 311 of the second transactor. In step 252, matches are detected or determined whereby, within a tolerance level, and an item or service in a desired inventory is compared to an item or service in another inventory. A tolerance level may be within what a person having ordinary skill in the art would consider an equivalent item. Thus, in this example, the first transactor has an item 212 in inventory 210, and the second transactor has item 212 in his desired inventory 321. This is a match if the item described is exactly the same or would be recognized by one having ordinary skill in the art as being the same item or analogous to the other. For example, item 212 may be described by the second transactor as, “Principles of Physics by Smith, 3^{rd} Edition” and be a book, while the first transactor 212 describes the item as, “Principles of Physics by Smith, 2^{nd} Edition” and this may be seen as close enough to be a match. Or, since each book has a separate ISBN number, a user or the overall system may not recognize this as a match.

A match may be found between a first and second transactor (which, in this case is used to describe someone carrying out a transaction or who has the potential to carry out a transaction), but in embodiments of the invention, a location must also be determined. Suggesting a transactor may only occur if the transactors are within a certain distance from each other. As described above with reference to FIG. 2, any one of the addresses used or other desired address may be used and weighted higher when calculating rankings or an order in which to present transactors to the first transactor. The determination of distances between parties when a match of products has been found is such that transportation costs and time it takes to meet with the other transactor can be taken into account.

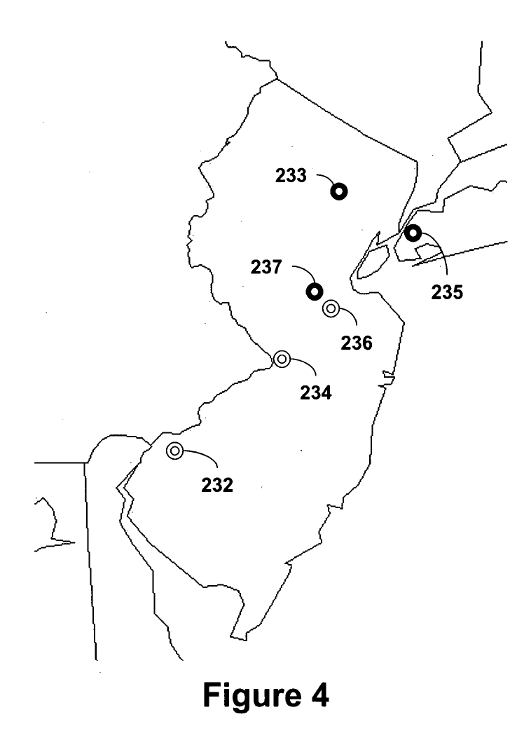

FIG. 4 shows locations of a first and second transactor in an embodiment of the invention. The location labels correspond to those of the first and second transactor of FIG. 3. In embodiments of the invention, there may be one, two, three, or more addresses or locations provided by each transactor. Or, no location can be provided and a distance between this transactor and another is then defined as infinite and receives zero relative weight when ranking transactors. As shown in FIG. 4, the first transactor may have a home address 232 in Cherry Hill, N.J., a work address 234 in Trenton, N.J., and a school address 236 in Piscataway, N.J. The second transactor may have a home address 233 in Wayne, N.J., a work address 235 in New York, N.Y., and a school address 237 in New Brunswick, N.J. If both parties choose to allow their school addresses to figure into the determination of distance between them and another transactor, then the closest distance, calculated in embodiments of the invention is from address 236 to address 237. The shorter the distance, the higher the relative score for distances and, thus, the higher the ranking between the transactors.

However, in embodiments of the disclosed technology, one or more of the transactors may desire not to have a school address factor into the calculations. This may be an automated process initiated by a transactor, whereby a school address is not used during months when the transactor does not reside at or travel to a school location. Supposing, for example, if the transactor's addresses 236 and 237 are not currently active, then the distance between the transactors is determined based on, for example, addresses 233 and 234. Any combination of addresses may be used for any reason.

In some cases, an item or service may only be available at a certain location. For example, referring again to FIG. 3, service 216 is also matched between the first transactor's inventory and the second transactor's desired inventory. If service 216 is, for example, dental services, the dentist (transactor 310) may only be available to conduct such services at work address 234 which, in this case, is in Trenton, N.J. Thus, if a match is determined between transactors based on service 216, then distance between any location of the second transactor and the work address of the first transactor is factored into the calculations. In such a case, however, there may be multiple matches, and other matches may allow for use of a home address of the first transactor. In such a case, multiple rankings of the transactors may be made, and the second transactor may be suggested to the first transactor in two different iterations with two different rankings.

Referring again to FIG. 3, group association may be compared between the first and second transactor. In this case, both transactors belong to group 242 and group 244, which may be a school association (a person may desire to trade books only with someone at his school for ease of distance and trustworthiness), someone amongst his circle of friends (such as out to a 6^{th} degree connection on a social network platform; embodiments of the invention may interface with such a platform to garner such data or be executed as an application on a social network platform as is known in the art), or the like.

In order to determine a ranking of transactors, in step 254 a relative weight to the match may be assigned. For example, for each match a score of “1” may be computed. In the example shown in FIG. 3, there are 8 matches of inventory to desired inventory between the first and second transactor, so a score of 8 may be assigned to the matches. This may be modified based on the preferences of the first transactor (the transactor for which the rankings are being calculated). Matches in the first transactor's inventory might be given a relative score of “1.25,” and matches in the first transactor's desired inventory might be given a relative score of “0.80,” for example. In such a case, the total relative score for the matches would be 8.20. Then, a relative score based on distance might be calculated, such as by taking the relative score determined for inventory matches and multiplying it by the inverse of the distance. If the distance away is 10 miles, then the relative score might be 8/10 or 0.8. If the distance away is 50 miles, then the relative score might be 8/50 or 0.16. A known distance might be assumed to be a 500 mile distance (i.e., requiring the use of the mail system or a courier and causing services to not been seen as matches). In this manner, closer distances result in higher relative scores. A matched group association might add 25% to the relative score. Thus, for example, the 0.8 relative score would become 1 and the 0.16 score would become 0.2.

In embodiments of the invention, a transactor, such as the first transactor, may determine a weight which he wants to assign to various portions of the match. Perhaps, in a query, the transactor only wants to see matches which have service 228 available. All other matches would be ignored and not presented. Or, the transactor might want to weight services or items, or desired inventory or inventory higher than another of these indicia. Or, any location within a certain radius may be defined as having a first relative weight (i.e., within 10 miles is given a relative weight of “2”); within a second radius may be defined as having a second relative weight (i.e., within 25 miles is given a relative weight of “1”); and within a third radius is given a third relative weight (i.e., within 50 miles is given a relative weight of “0.5”). Anything beyond the third radius may be dropped and not considered for a suggestion at all.

It should be understood that, when ranking the transactors and suggesting at least one transactor to conduct a transaction with, the results will likely be different when conducted for each transactor and, further, may be different even when conducting it for the first and second transactor. Some information may be deemed private (such as an address) but used when calculating an address on behalf of a transactor. Still further, while embodiments of the invention have generally been shown between a first and second transactor, this is so as not to overcomplicate the disclosure. Embodiments of the invention are contemplated between a first transactor and any number of other transactors.

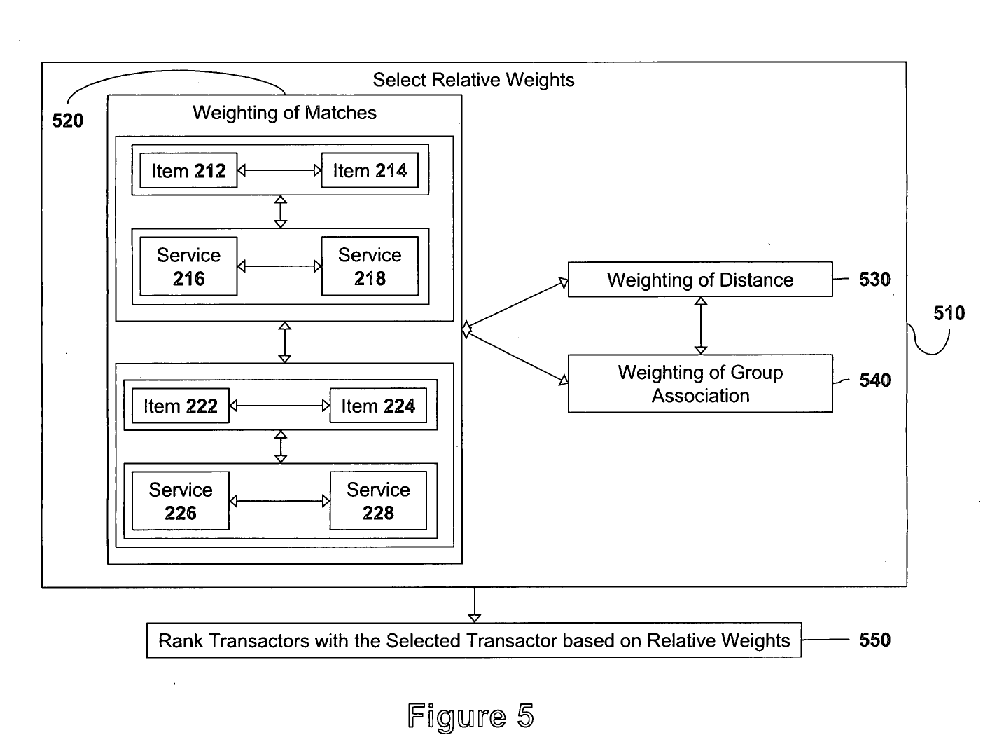

FIG. 5 shows a method of selecting relative weights which are used to rank transactors in embodiments of the invention. The relative weights may be predetermined, such as by using standard weights, or may be adjusted due to any condition such as a user selection, value of products or services being offered/desired, combinations of the above, and so forth. In step 520, relative weights are selected. Each item in an inventory, such as items 212 and 214, may be weighted with respect to each other. Each service or inventory may be weighted with respect to any other, such as service 216 and service 218. The items and services in an inventory may be weighted with respect to each other. In a similar manner, the items and services in a wanted inventory (222, 224, 226, and 228, shown as examples in FIG. 5) may be weighted with respect to one another. The inventory of the transactor and the wanted inventory may then be weighted relative to one another. The above is then collated into a weighting of the matches 520 between a selected transactor and another, based on the quantity of matches and relative weights of the matches made.

The weighting of matches 520 is carried out relative to a weighting of distance 530 and a weighting of group association 540, where applicable. These weightings may be dynamic, that is, adjusted based on weightings of individual items and factors within each weighting. Weighting of distance may further depend on which location is used, as described above with reference to the previous figures.

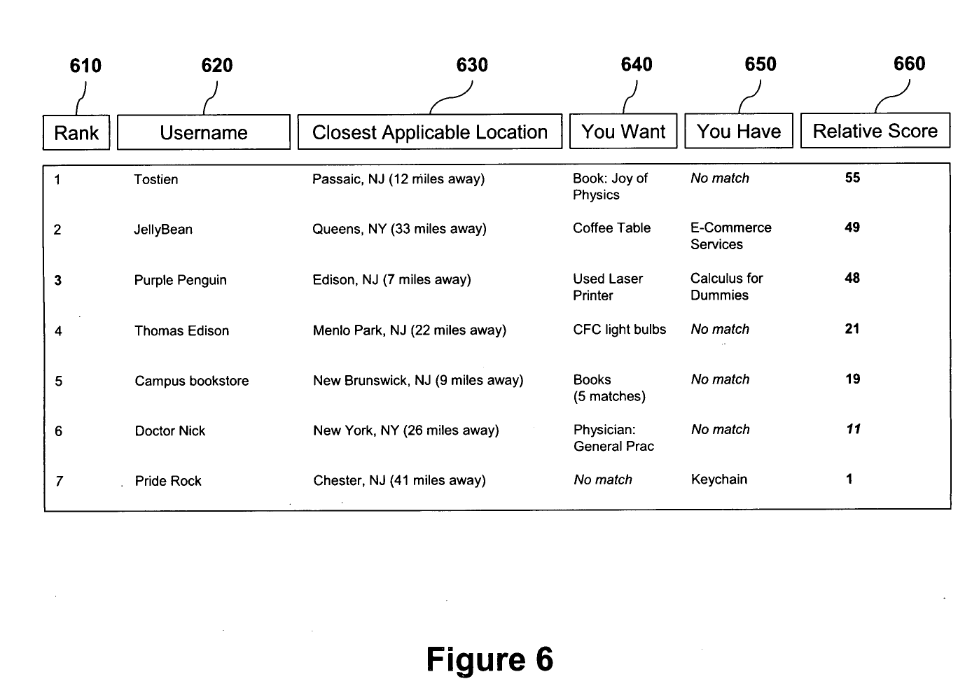

FIG. 6 shows an example of information presented to a transactor when suggesting at least one transaction in an embodiment of the invention. Here, the following data is displayed. The rank 610, that is, the matches in order of quality, a username 620, a closest applicable location 630, the inventory of other user which matches the inventory wanted by the selected transactor (“you want” 640), the inventory of the selected transactor which matches (“you have” 650), and a relative score 660 are shown. It should be noted that, depending on the relative weightings, the ranking 610 is not necessarily solely dependent on the number of matches or closeness of distance. For example, perhaps an automated system or a transactor weighted having the book, “Joy of Physics” extremely high, because its value is high or the book is extremely sought after by the transactor. In other words, the relative weight of any particular item or category may influence the rankings and order of suggestions of a transaction between transactors. A transactor or other party may also change the relative weightings, an item or service which must be matched, and so forth, and execute another query which will return a new set of results.

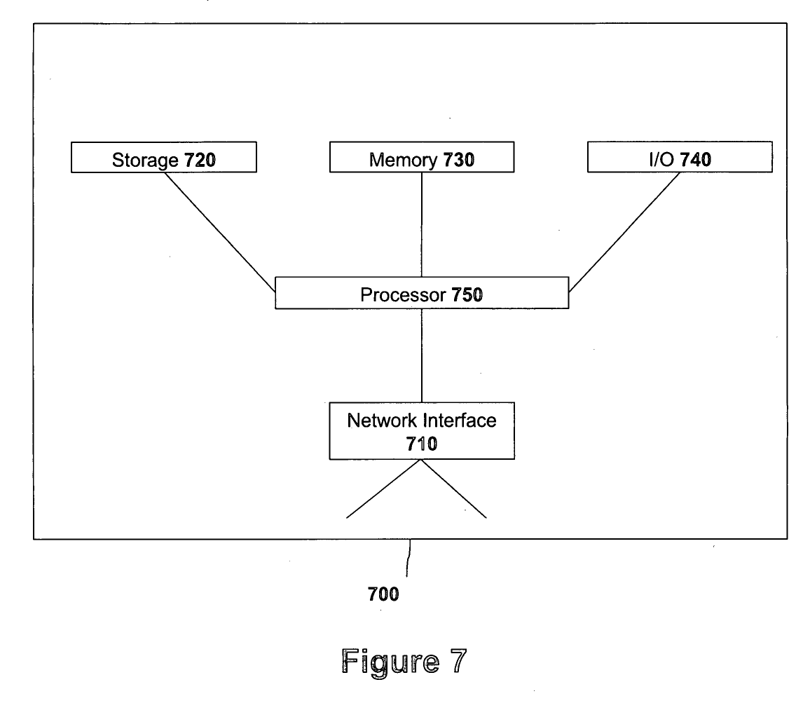

FIG. 7 shows a high-level block diagram of a computer that may be used to carry out the invention. Computer 700 contains a processor 704 that controls the overall operation of the computer by executing computer program instructions which define such operation. The computer program instructions may be stored in a storage device 708 (e.g., magnetic disk, database) and loaded into memory 712 when execution of the computer program instructions is desired. Thus, the computer operation will be defined by computer program instructions stored in memory 712 and/or storage 708, and the computer will be controlled by processor 704 executing the computer program instructions. Computer 700 also includes one or a plurality of input network interfaces for communicating with other devices via a network (e.g., the Internet). Computer 700 also includes one or more output network interfaces 716 for communicating with other devices. Computer 700 also includes input/output 724, representing devices which allow for user interaction with the computer 700 (e.g., display, keyboard, mouse, speakers, buttons, etc.).

One skilled in the art will recognize that an implementation of an actual computer will contain other components as well, and that FIG. 5 especially, and the figures in general, are a high level representation of some of the components of a computer or switch and are for illustrative purposes. It should also be understood by one skilled in the art that the method and devices depicted or described in FIGS. 1 through 6 may be implemented on a device such as is shown in FIG. 7.

While the invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A method for suggesting a transaction comprising:
comparing an inventory of a transactor with a desired inventory of a plurality of other transactors and a desired inventory of said transactor with an inventory of said plurality of other transactors;
determining a distance between said at least one transactor and said plurality of other transactors;
ranking said plurality of other transactors to said at least one transactor based on said comparing and said determining; and
suggesting at least one transaction between said transactor and at least one of said plurality of other transactors.

2. The method of claim 1, where said comparing further comprises comparing a group association between said transactor and said plurality of other transactors.

3. The method of claim 1, wherein said ranking is further based on assigning a relative weight to each of said comparing and said determining.

4. The method of claim 3, wherein said relative weight is assigned by said at least one transactor.

5. The method of claim 1, wherein at least two items selected from a said inventory or a said desired inventory are assigned a relative weight in said ranking.

6. The method of claim 5, wherein said relative weight is assigned by said transactor.

7. The method of claim 5, wherein said relative weight is assigned by a transactor in said plurality of other transactors.

8. The method of claim 1, wherein a plurality of locations is received from at least one of said transactors, and said determination of distance is based on said closest distances between said at least one transactor and said plurality of other transactors.

9. The method of claim 1, wherein a plurality of locations is received from at least one of said transactors, and said determination of distance is based on a relative weight assigned to each said location.

10. The method of claim 9, wherein said relative weight of each said location is assigned to at least two locations, each by a separate transactor.

11. A computer readable storage medium for suggesting a transaction comprising a set of instructions, said instructions comprising:
instructions for comparing an inventory of a transactor with a desired inventory of a plurality of other transactors, and a desired inventory of said transactor with an inventory of said plurality of other transactors;
instructions for determining a distance between said at least one transactor and said plurality of other transactors;
instructions for ranking said plurality of other transactors to said at least one transactor based on said comparing and said determining; and
instructions for suggesting at least one transaction between said transactor and at least one of said plurality of other transactors.

12. The computer readable storage medium of claim 11, where said comparing further comprises comparing a group association between said transactor and said plurality of other transactors.

13. The computer readable storage medium of claim 11, wherein said step of ranking is further based on assigning a relative weight to at least each of said comparing and said determining.

14. The computer readable storage medium of claim 13, wherein said relative weight is assigned by said at least one transactor.

15. The computer readable storage medium of claim 11, wherein at least two items selected from a said inventory or a said desired inventory are assigned a relative weight in said ranking.

16. The computer readable storage medium of claim 15, wherein said relative weight is assigned by said transactor.

17. The computer readable storage medium of claim 15, wherein said relative weight is assigned by a transactor in said plurality of other transactors.

18. The computer readable storage medium of claim 11, wherein a plurality of locations is received from at least one of said transactors, and said determination of distance is based on said closest distances between said at least one transactor and said plurality of other transactors.

19. The computer readable storage medium of claim 11, wherein a plurality of locations is received from at least one of said transactors, and said determination of distance is based on a relative weight assigned to each said location.

20. The computer readable storage medium of claim 13, wherein a said relative weight is based on a monetary value of an item or services in an inventory.
